(19) United States
(12) Patent Application Publication
(10) Pub. No.: US 2022/0321778 A1
(43) Pub. Date: Oct. 6, 2022

(54) CAMERA POSITIONING TO MINIMIZE ARTIFACTS

(71) Applicant: QUALCOMM Incorporated, San Diego, CA (US)

(72) Inventors: Pawan Kumar Baheti, Bangalore (IN); Pushkar Gorur Sheshagiri, Bengaluru (IN)

(21) Appl. No.: 17/217,744

(22) Filed: Mar. 30, 2021

(51) Int. Cl. H04N 5/232; H04N 5/247; G06T 7/80; G06T 7/55; G06K 9/00; G06T 7/20; H04N 13/282; B25J 13/08

(52) U.S. Cl. CPC H04N 5/23238; H04N 5/247; G06T 7/80; G06T 7/55; H04N 5/23299; H04N 5/23219; G06K 9/00228; G06T 7/20; H04N 13/282; B25J 13/08; G06T 2207/20104; G06T 2207/30201; G06T 2207/20164; G06T 2207/30168

(57) ABSTRACT

An example method of capturing a 360° field-of-view image includes capturing, with one or more processors, a first portion of a 360° field-of-view using a first camera module and capturing, with the one or more processors, a second portion of the 360° field-of-view using a second camera module. The method further includes determining, with the one or more processors, a target overlap region based on a disparity in a scene captured by the first portion and the second portion and causing, with the one or more processors, the first camera module, the second camera module, or both the first camera module and the second camera module to reposition to a target camera setup based on the target overlap region. The method further includes capturing, with the one or more processors, the 360° field-of-view image with the first camera and the second camera arranged at the target camera setup.

### TECHNICAL FIELD

The disclosure relates to video rendering of image content, such as, for example, 360° image data.

### BACKGROUND

In certain types of video rendering, such as 360° video, a viewer can perceive multiple different views of the image content. For instance, while a viewer is viewing the image content on a display, the viewer can select a different view from which to view the content. For 360° video, the viewer can interface with the display to change the angle from which the viewer is viewing the image content.

### SUMMARY

In general, this disclosure describes techniques for generating 360° image content by stitching together image content captured by two camera modules, each camera having a fisheye lens. The two cameras together capture 360° of image content (e.g., a sphere of image content). In examples described in this disclosure, each camera module may capture more than half of the sphere, and the overlapping portion from each of the captured video content is used to determine the manner in which to stitch the captured video content.

The two captured portions of the image content may be referred to as a first portion of the image content and a second portion of the image content, and image content of the first portion and the second portion may be less than the entire sphere of image content. The image content of the first portion may be more than half of the image content of the sphere of image content, and the image content of the second portion may be more than half of the image content of the sphere of image content.

A graphics processing unit (GPU) may utilize texture mapping techniques to overlay the captured image content onto 3D mesh models. Because each portion includes more than half of the sphere of image content, there is overlapping image content (e.g., an overlap region) in the first and second portions. In generating the sphere of image content, the GPU may account of the overlapping image content by blending the image content in the overlapping portion. However, such texture mapping techniques may generate warping artifacts, which are particularly undesirable at a region of interest (e.g., a face). The warping artifacts may result from parallax (e.g., a spatial difference of the fisheye lens capturing the region of interest. Moreover, features that are relatively close to the camera system (e.g., a foreground) may result in a relatively high amount of warping artifacts compared to features that are relatively far from the camera system (e.g., a background). As such, camera systems relying on texture mapping techniques may experience warping artifacts in regions of interest, particularly, in regions of interest positioned in a foreground.

In accordance with the techniques of the disclosure, a camera system may rotate a camera setup (e.g., position a camera mount or move a robotic device) to position an overlap region away from a region of interest based on a disparity in a scene. As used herein, a disparity in a scene may refer to a distance of objects and the camera setup. In this way, the camera system may help to reduce warping artifacts, particularly, warping artifacts resulting from parallax compared to systems that do not use a disparity in the scene, which may help to improve user satisfaction.

Moreover, techniques described herein may rotate a camera setup along a single axis to permit applications in robotic devices. For example, a robotic device may not be configured to hover at a tilted angle and the camera system may reposition the robotic device by a rotation of a platform around single axis (e.g., a yaw axis of the robotic device) to achieve a target camera setup. In this way, the camera system may help to reduce warping artifacts in images captured using a robotic device, particularly, warping artifacts resulting from parallax compared to systems that do not use a disparity in the scene, which may help to improve user satisfaction.

In one example, this disclosure describes a method of capturing a 360° field-of-view image that includes capturing, with one or more processors, a first portion of a 360° field-of-view using a first camera module and capturing, with the one or more processors, a second portion of the 360° field-of-view using a second camera module. The method further includes determining, with the one or more processors, a target overlap region from a plurality of potential overlap regions of a scene captured by the first portion and the second portion based on a disparity in the scene and causing, with the one or more processors, the first camera module, the second camera module, or both the first camera module and the second camera module to reposition to a target camera setup based on the target overlap region. The method further includes capturing, with the one or more processors, the 360° field-of-view image with the first camera and the second camera arranged at the target camera setup.

In another example, this disclosure describes a device for capturing a 360° field-of-view image includes a first camera module, a second camera module, a memory, and one or more processors implemented in circuitry. The first camera module is configured to capture a first portion of a 360° field-of-view. The second camera module is configured to capture a second portion of the 360° field-of-view. The memory is configured to store the first portion of the 360° field-of-view and the second portion of the 360° field-of-view. The one or more processors are configured to cause the first camera to capture the first portion of a 360° field-of-view and cause the second camera to capture the second portion of the 360° field-of-view. The one or more processors are further configured to determine a target overlap region from a plurality of potential overlap regions of a scene captured by the first portion and the second portion based on a disparity in the scene and cause the first camera module, the second camera module, or both the first camera module and the second camera module to rotate to a target camera setup based on the target overlap region. The one or more processors are further configured to capture the 360° field-of-view image with the first camera and the second camera arranged at the target camera setup.

In another example, this disclosure describes a device for generating image content includes means for capturing a first portion of a 360° field-of-view using a first camera module and means for capturing a second portion of the 360° field-of-view using a second camera module. The device further comprises means for determining a target overlap region from a plurality of potential overlap regions of a scene captured by the first portion and the second portion based on a disparity in the scene and means for causing the first camera module, the second camera module, or both the first camera module and the second camera module to reposition to a target camera setup based on the target overlap region. The device further comprises means for capturing the 360° field-of-view image with the first camera and the second camera arranged at the target camera setup.

In another example, this disclosure describes a computer-readable storage medium having stored thereon instructions that, when executed, configure a processor to capture a first portion of a 360° field-of-view using a first camera module and capture a second portion of the 360° field-of-view using a second camera module. The one or more instructions further cause the processor to determine a target overlap region from a plurality of potential overlap regions of a scene captured by the first portion and the second portion based on a disparity in the scene and cause the first camera module, the second camera module, or both the first camera module and the second camera module to reposition to a target camera setup based on the target overlap region. The one or more instructions further cause the processor to capture the 360° field-of-view image with the first camera and the second camera arranged at the target camera setup.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example device for capturing 360° video, in accordance with one or more example techniques described in this disclosure.

FIGS. 2A and 2B are pictorial diagrams illustrating images captured from the device of FIG. 1, in accordance with one or more example techniques described in this disclosure.

FIG. 3 is a block diagram of a device configured to perform one or more of the example techniques described in this disclosure.

FIG. 4 is a conceptual diagram illustrating an example dual-fisheye arrangement, in accordance with one or more example techniques described in this disclosure.

FIG. 5 is a conceptual diagram illustrating of artifacts due to parallax, in accordance with one or more example techniques described in this disclosure.

FIG. 6 is a conceptual diagram illustrating an example parallax computation, in accordance with one or more example techniques described in this disclosure.

FIG. 7A is a conceptual diagram illustrating a first process in directing a camera system to reduce warping artifacts, in accordance with one or more example techniques described in this disclosure.

FIG. 7B is a conceptual diagram illustrating a second process in directing a camera system to reduce warping artifacts, in accordance with one or more example techniques described in this disclosure.

FIG. 8 is a flow diagram illustrating a process for generating a 360° image to reduce warping artifacts, in accordance with one or more example techniques described in this disclosure.

FIG. 9 is a pictorial diagram illustrating image content comprising a region of interest in a foreground, in accordance with one or more example techniques described in this disclosure.

FIG. 10A is a conceptual diagram illustrating a first process for texture mapping techniques, in accordance with one or more example techniques described in this disclosure.

FIG. 10B is a conceptual diagram illustrating a second process for texture mapping techniques, in accordance with one or more example techniques described in this disclosure.

FIG. 10C is a conceptual diagram illustrating a third process for texture mapping techniques, in accordance with one or more example techniques described in this disclosure.

FIG. 11 is a conceptual diagram illustrating candidate columns for a stitched output, in accordance with one or more example techniques described in this disclosure.

FIG. 12 is a conceptual diagram illustrating a disparity computation using dynamic programming, in accordance with one or more example techniques described in this disclosure.

FIG. 13 is a conceptual diagram illustrating a robotic device, in accordance with one or more example techniques described in this disclosure.

FIG. 14A is a conceptual diagram illustrating a first process of a rotation of cameras mounted on a robotic device, in accordance with one or more example techniques described in this disclosure.

FIG. 14B is a conceptual diagram illustrating a second process of a rotation of cameras mounted on a robotic device, in accordance with one or more example techniques described in this disclosure.

FIG. 15 is a flowchart illustrating an example method of operation according to one or more example techniques described in this disclosure.

### DETAILED DESCRIPTION

The example techniques described in this disclosure are related to generating a 360° video or image. In a 360° video or image, the video/image content forms a conceptual sphere around the viewer. The viewer can view image content from multiple perspectives (e.g., in front, behind, above, and all around the user), and such image content may be called a 360° image.

In this disclosure, an image that includes 360° of image content or viewable content may refer to an image that includes content for all perspectives (e.g., content above, below, behind, in front, and on each side of the user). For example, conventional images may capture slightly less than 180-degree of image content, and do not capture content on the sides of the camera.

In general, 360° video is formed from a sequence of 360° images. Accordingly, the example techniques described in this disclosure are described with respect to generating 360° image content. For 360° video content, 360° images can be displayed sequentially. In some examples, a user may desire to take only a 360° image (e.g., as a snapshot of the entire 360° surrounding of the user), and the techniques described in this disclosure are applicable to such example cases as well.

The 360° image content may be captured with a camera device. For example, the 360° image content may be captured using two camera modules (e.g., with fisheye lenses) positioned to capture opposite portions of the sphere of image content. The two camera modules may capture respective portions of the full sphere of the 360° video.

360° video content may be used in virtual reality, gaming, surveillance, or other applications. Additionally, applications may be directed to a “selfie-with-drone” concepts, where a user selects a region of interest for cameras mounted on a robotic device to capture. For example, the robotic device may comprise multiple cameras covering a 360° field-of-view (FOV) in both a horizontal direction and a vertical direction. For instance, the robotic device may comprise two camera modules (e.g., with fisheye lenses) configured to capture more than a 180° field-of-view. In this instance, data from each one of the two camera modules may be synchronously captured and stitched to generate a 360 canvas or scene.

The example techniques described in this disclosure describes ways to generate a 360° image (e.g., scene) using the two images (e.g., circular images). A graphics processing unit (GPU) or other processor may utilize texture mapping techniques to render the two images, each having a portion of a sphere of image content, and may blend the rendered portions of the image content to generate the sphere of image content.

Differences between a physical location of cameras may generate artifacts due to parallax when applying texture mapping techniques. For example, a first camera module and second camera module may be spaced apart, resulting in a different point of view when viewing the same object. The different point of view when viewing the same object may result in the same object appearing shifted in images captured by the first and second fisheye cameras. Moreover, the shifting of the same object is increased as a distance between the object and the first and second fisheye cameras is decreased. Techniques for averaging sample values may help to blend or blur the shift, but may result in a stitched output that is warped.

In accordance with the techniques of the disclosure, a camera system may rotate a camera setup to position an overlap region away from a region of interest based on a disparity in the scene. In this way, the camera system may help to avoid warping artifacts resulting from parallax in features that are relatively close to the camera system that will likely result in a relatively high amount of warping artifacts.

For example, a camera system may determine a cost for each potential overlap region based on a disparity in a scene (e.g., a distance of objects in the potential overlap region and the camera setup) and rotate the camera setup to a lowest cost overlap region (e.g., a target overlap region). The cost of each potential overlap region may be calculated further based on one or more of whether the potential overlap region comprises a detected region of interest (e.g., a face), a user-selected region of interest, an activity, or sharp features.

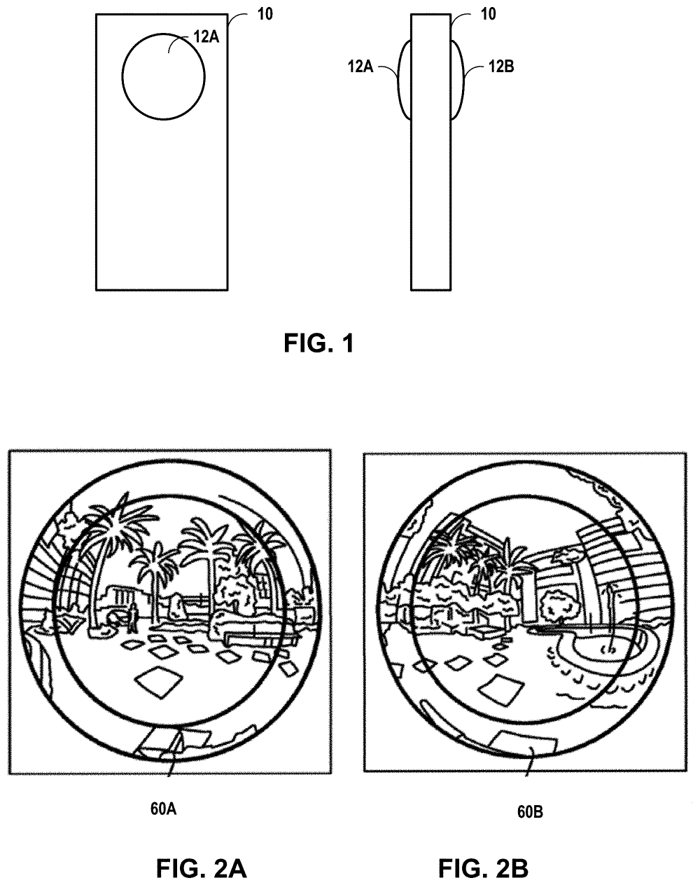

FIG. 1 is a block diagram illustrating an example device for capturing 360° video, in accordance with one or more example techniques described in this disclosure. As illustrated, computing device 10 may comprise a video capture device that includes camera module 12A and camera module 12B located on opposite sides of computing device 10 to capture full 360° video content. Other orientations of camera module 12A and 12B may be possible. In some examples, camera module 12A may include a first fisheye lens and camera module 12B may include a second fisheye lens. In some examples, however, camera module 12A and/or camera module 12B may use other types of lenses. As described above, the 360° video content may be considered as a sequence of 360° images (e.g., frames of the video). The example techniques described in this disclosure describe techniques related to the images, which can be used for purposes of still images (e.g., 360° snapshot) or for images that form a video (e.g., 360° video).

A viewer may interact with computing device 10 to capture the 360° video/image, where each one of camera module 12A and 12B captures a portion of the 360° video/image, and the two video/image streams from the camera module 12A and 12B are blended together to create the 360° video/image. In some cases, the blending together of the video/image streams may cause a visible seam between the two streams.

There may be various ways in which a viewer interacts with computing device 10. As one example, the viewer may interact with computing device 10 with a push button located on computing device 10. As another example, a viewer may interact with computing device 10 via a displayed interface (e.g., graphical user interface (GUI)).

In some examples, computing device 10 may be a camera device (e.g., fisheye camera device) that provides no display and may or may not have onboard processing capabilities. For example, computing device 10 may be mounted on a robotic device (e.g., a drone). In some examples, computing device 10 outputs the captured image to another device for processing (e.g., a processing device). This processing device may provide the primary or secondary mechanism for viewer interaction. For example, the viewer may execute an application on the processing device that causes computing device 10 to sink with the processing device, where the processing device is the master and computing device 10 is the servant device. The viewer may then, via the processing device, cause computing device 10 to capture a 360° image, and computing device 10 outputs the images back to the processing device for display. In some examples, even when a processing device is used to capture the 360° image, the viewer may still interact with computing device 10 for capturing the 360° image, but computing device 10 will output the image to the processing device for display.

In accordance with the techniques of the disclosure, camera module 12A may capture a first portion of a 360° field-of-view. Camera module 12B may capture a second portion of the 360° field-of-view. Computing device 10 may select a target overlap region from a plurality of potential overlap regions of a scene captured by the first portion and the second portion based on a disparity in the scene. Computing device 10 may cause a platform or housing that holds camera module 12A, camera module 12B, or both camera module 12A and camera module 12B to reposition to a target camera setup based on the target overlap region. Camera module 12A and camera module 12B may capture the 360° field-of-view image with camera module 12A and camera module 12B arranged at the target camera setup. Accordingly, camera module 12A and camera module 12B may be rotated to position an overlap region away from a region of interest based on the disparity in the scene. In this way, the computing device 10 may help to avoid warping artifacts resulting from parallax in features that are relatively close to computing device 10 that will likely result in a relatively high amount of warping artifacts.

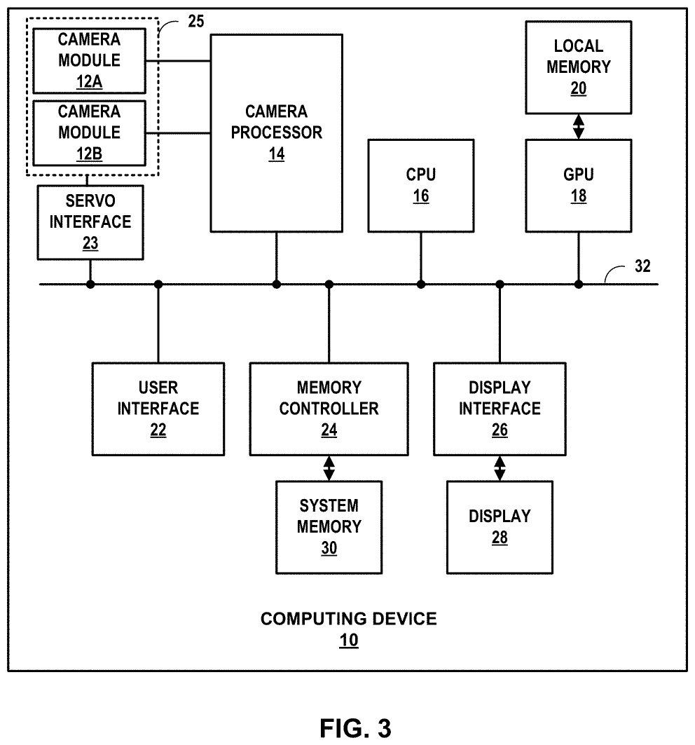

FIGS. 2A and 2B are pictorial diagrams illustrating images captured from computing device 10 of FIG. 1. As illustrated, the output of the two images captured by camera modules 12A and 12B are circular images (e.g., round images). For example, FIG. 2A may represents an image captured by camera module 12A, which may form a first portion of a 360° field-of-view image 60A. FIG. 2B may represents an image captured by camera module 12B, which may form a second portion of a 360° field-of-view image 60B. In response to a viewer interaction to capture an image, a camera processor, illustrated in FIG. 3, may receive the image content captured by camera modules 12A and 12B and processes the image content to generate FIGS. 2A and 2B. In some examples, FIGS. 2A and 2B may be part of a common image frame.

As illustrated, FIGS. 2A and 2B are circular images illustrating image content that appears bubble-like. If the two circular images are stitched together, the resulting image content would be for the entire sphere of image content (e.g., 360° of viewable content).

However, the images captured by camera modules 12A and 12B may encompass more than half of the 360° of viewable content. To capture half of the 360° of viewable content, camera module 12A would have captured 180-degree of the 360° of viewable content, and camera module 12B would have captured the other 180-degree of the 360° of viewable content. In some examples, camera modules 12A and 12B may each capture more than 180-degrees of the 360° of viewable content. For instance, camera modules 12A and 12B may capture approximately 200-degrees of the viewable content (e.g., content slightly behind the side of computing device 10 and extending all around).

Because each of camera modules 12A and 12B capture more than 180-degrees of the 360° of viewable content, there is some image content overlap in the images generated from the content captured by camera modules 12A and 12B. A graphics processing unit (GPU), as illustrated in FIG. 3, may utilize this overlap in image content to apply texture mapping techniques that blend the sphere of image content for display.

However, such texture mapping techniques may generate warping artifacts, which are particularly undesirable at a region of interest (e.g., a face). The warping artifacts may result from parallax (e.g., a spatial difference of the fisheye lens capturing the region of interest). Moreover, features that are relatively close to the camera system (e.g., a face) may result in a relatively high amount of warping artifacts compared to features that are relatively far from the camera system (e.g., a background). As such, camera systems relying on texture mapping techniques may experience warping artifacts in regions of interest, particularly, in regions of interest positioned in a foreground.

In accordance with the techniques of the disclosure, computing device 10 may rotate a camera setup that holds camera modules 12A and 12B to position an overlap region away from a region of interest based on a disparity in a scene. As used herein, a disparity in a scene may refer to a distance of objects and the camera setup. In this way, computing device 10 may help to reduce warping artifacts, particularly, warping artifacts resulting from parallax compared to systems that do not use a disparity in the scene, which may help to improve a user satisfaction.

FIG. 3 is a block diagram of a device configured to perform one or more of the example techniques described in this disclosure. Examples of computing device 10 include a computer (e.g., personal computer, a desktop computer, or a laptop computer, a robotic device, or a computing device housed in a robotic device), a mobile device such as a tablet computer, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA). Additional examples of computing device 10 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 3, computing device 10 includes first camera module 12A and second camera module 12B, at least one camera processor 14, a central processing unit (CPU) 16, a graphical processing unit (GPU) 18 and local memory 20 of GPU 18, user interface 22, memory controller 24 that provides access to system memory 30, and display interface 26 that outputs signals that cause graphical data to be displayed on display 28. Although FIG. 3 illustrates camera modules 12A and 12B as part of the same device that includes GPU 18, the techniques described in this disclosure are not so limited. In some examples, GPU 18 and many of the various other components illustrated in FIG. 3 may be on a different device (e.g., a processing device), where the captured video content from camera modules 12A and 12B is outputted to the processing device that includes GPU 18 for post-processing and blending of the image content to generate the 360° video/image.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Various other permutations and combinations are possible, and the techniques should not be considered limited to the example illustrated in FIG. 3.

The various components illustrated in FIG. 3 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 3 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXensible Interface (AXI) bus) or another type of bus or device interconnect. It should be noted that the specific configuration of buses and communication interfaces between the different components shown in FIG. 3 is merely exemplary, and other configurations of computing devices and/or other image processing systems with the same or different components may be used to implement the techniques of this disclosure.

Camera processor 14 may be external to computing device 10; however, it may be possible for camera processor 14 to be internal to computing device 10, as illustrated. For ease of description, the examples are described with respect to the configuration illustrated in FIG. 3. In some examples, camera module 12A and camera module 12B may each comprise a camera processor 14 for to increase parallel processing.

Camera processor 14 is configured to receive image data from respective pixels generated using camera module 12A and camera module 12B and process the image data to generate pixel data of respective fisheye images (e.g., the circular images). Although one camera processor 14 is illustrated, in some examples, there may be a plurality of camera processors (e.g., one for camera module 12A and one for camera module 12B). Accordingly, in some examples, there may be one or more camera processors like camera processor 14 in computing device 10.

Camera processor 14 may perform the same operations on current received from each of the pixels on each of camera module 12A and camera module 12B. Each lane of the SIMD architecture may include an image pipeline. The image pipeline includes hardwire circuitry and/or programmable circuitry (e.g., at least one of fixed-function or programmable circuitry) to process the output of the pixels.

Camera processor 14 may perform some additional post-processing to increase the quality of the final image. For example, camera processor 14 may evaluate the color and brightness data of neighboring image pixels and perform demosaicing to update the color and brightness of the image pixel. Camera processor 14 may also perform noise reduction and image sharpening, as additional examples.

Camera processor 14 may output the resulting images (e.g., pixel values for each of the image pixels) to system memory 30 via memory controller 24. Each of the images may be a combined together to form the 360° video/images. For example, one or more of GPU 18, CPU 16, or some other processing unit including camera processor 14 itself may perform the blending to generate the video content. For ease of description, the examples are described with respect to the processing circuitry of GPU 18 performing the operations. However, other processing circuitry may be configured to perform the example techniques. In some cases, GPU 18 may combine the images and generate the 360° video/images in real-time, but in other examples, the operations of combining the images to generate the 360° video/images need not necessarily be in real-time.

CPU 16 may comprise a general-purpose or a special-purpose processor that controls operation of computing device 10. A user may provide input to computing device 10 to cause CPU 16 to execute one or more software applications. The software applications that execute on CPU 16 may include, for example, a word processor application, a web browser application, an email application, a graphics editing application, a spread sheet application, a media player application, a video game application, a graphical user interface application or another program. The user may provide input to computing device 10 via one or more input devices (not shown) such as a keyboard, a mouse, a microphone, a touch pad or another input device that is coupled to computing device 10 via user interface 22.

One example of the software application is the camera application. CPU 16 executes the camera application, and in response, the camera application causes CPU 16 to generate content that display 28 outputs. For instance, display 28 may output information such as light intensity, whether flash is enabled, and other such information. The user of computing device 10 may interface with display 28 to configure the manner in which the images are generated (e.g., with or without flash, and other parameters). The camera application also causes CPU 16 to instruct camera processor 14 to process the images captured by camera module 12A and 12B in the user-defined manner.

The software applications that execute on CPU 16 may include one or more graphics rendering instructions that instruct CPU 16 to cause the rendering of graphics data to display 28, e.g., by instructing GPU 18. In some examples, the software instructions may conform to a graphics application programming interface (API), such as, e.g., an Open Graphics Library (OpenGL®) API, an Open Graphics Library Embedded Systems (OpenGL ES) API, an OpenCL API, a Direct3D API, an X3D API, a RenderMan API, a WebGL API, or any other public or proprietary standard graphics API. The techniques should not be considered limited to requiring a particular API.

As one example, the user may execute the camera application and interact with computing device 10 to capture the 360° video. After camera processor 14 stores the resulting images (e.g., the circular images of FIGS. 2A and 2B) in system memory 30, the camera application may cause CPU 16 to instruct GPU 18 to render and blend the images. The camera application may use software instructions that conform to an example API, such as the OpenGL API, to instruct GPU 18 to render and blend the images. As an example, the camera application may issue texture mapping instructions according to the OpenGL API to cause GPU 18 to render and blend the images.

In response to the received instructions, GPU 18 may receive the image content of the circular images and blend the image content to generate the 360° video. Display 28 displays the 360° video. The user may interact with user interface 22 to modify the viewing perspective so that the viewer can view the full 360° video (e.g., view above, behind, in front, and all angles of the 360 sphere).

Memory controller 24 facilitates the transfer of data going into and out of system memory 30. For example, memory controller 24 may receive memory read and write commands, and service such commands with respect to system memory 30 in order to provide memory services for the components in computing device 10. Memory controller 24 is communicatively coupled to system memory 30. Although memory controller 24 is illustrated in the example of computing device 10 of FIG. 3 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting images from camera processor 14, etc. System memory 30 may additionally store information for use by and/or generated by other components of computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 30 may include instructions that cause camera processor 14, CPU 16, GPU 18, and display interface 26 to perform the functions ascribed to these components in this disclosure. Accordingly, system memory 30 may be a computer-readable storage medium having instructions stored thereon that, when executed, cause one or more processors (e.g., camera processor 14, CPU 16, GPU 18, and display interface 26) to perform various functions.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

Camera processor 14, CPU 16, and GPU 18 may store image data, and the like in respective buffers that are allocated within system memory 30. Display interface 26 may retrieve the data from system memory 30 and configure display 28 to display the image represented by the generated image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 28 may be integrated within computing device 10. For instance, display 28 may be a screen of a mobile telephone handset or a tablet computer. Alternatively, display 28 may be a stand-alone device coupled to computing device 10 via a wired or wireless communications link. For instance, display 28 may be a computer monitor or flat panel display connected to a personal computer via a cable or wireless link.

In example techniques described in this disclosure, GPU 18 includes a graphics processing pipeline that includes processing circuitry (e.g., programmable circuitry and/or fixed-function circuitry). For example, GPU 18 may include texture mapping hardware circuitry used for performing the operations of the example techniques. GPU 18 may also include processing circuitry for the blending and mask generation for performing the operations of the example techniques.

For instance, GPU 18 may use texture mapping techniques to generate the image content that is to be rendered and blended. Texture mapping generally refers to the process by which an image is overlaid on-top-of (also referred to as “glued” to) a geometry. The image that is to be overlaid may be referred to as a color texture or simply texture, and CPU 16 may define the geometry. The color texture may be a two-dimensional (2D) image that is overlaid onto a 3D mesh model, but other dimensions of the color texture are possible such as 3D image.

As an example to assist with understanding texture mapping in general, the 3D mesh model may be an interconnection of a plurality of primitives that forms a wall, and the color texture may be a 2D image of a mural image. In this example, the geometry on which color texture is overlaid is the wall, and the color texture in the mural image. In texture mapping, CPU 16 outputs instructions to GPU 18 that corresponds 3D coordinates (e.g., x, y, z) of vertices of the primitives that form the wall with texture coordinates of the color texture. In this example, the texture coordinates of the color texture are the image pixel coordinates of the mural image normalized to be between 0 and 1.

GPU 18 may perform texture mapping to overlay a first circular image (e.g., circular image illustrated in FIG. 2A) onto a first 3D mesh model to generate a first portion of image content, and performs the texture mapping to overlay a second circular image (e.g., circular image illustrated in FIG. 2B) onto a second 3D mesh model to generate a second portion of the image content. The first and second 3D mesh models may be instances of the same 3D mesh model, or may be different 3D mesh models.

GPU 18 may also blend the first and second portions, and there may be various ways in which GPU 18 may blend the first and second portions. As one example, GPU 18 may blend the first and second portions based on the overlapping portion in the first and second portions. As described above, the image content in each of the first and second portions is more than 180-degrees of image content, meaning that there is some overlapping image content (e.g., image content that appears in both) the first and second portions.

This overlapping content occurs along the seams of the first and second portions (e.g., along with widest area of the first and second sub-capsules). GPU 18 may blend the overlapping portions so that the same image content does not appear twice in the final sphere of image content.

For example, GPU 18 may also perform alpha blending along the overlapping portions of the two portions. Alpha blending is a way to assign weighting that indicates the percentage of video content used from each of the portions when blending. For instance, assume there is a first portion and a second portion, where the first portion is to the left of the second portion. In this example, most of the image content of the first portion that is further away from the overlapping seam is used and little of the image content of the second portion is used in blending. Similarly, most of the image content of the second portion that is further away from the overlapping seam is used and little of the image content of the first portion is used in blending. Moving from left-to-right, more and more of the image content from the second portion and less of the image content from the first portion is used in blending. Accordingly, the alpha blending weighs contributions of image content from the first and second portions of the image content.

For instance, with alpha blending in the overlapping area, there is a weighted contribution of overlapping pixels. If on the left of the overlapping seam, but still overlapping, GPU 18 weights the pixels on left sphere more than those on the right sphere (e.g., more weight to pixels on left sphere than right sphere). If on the right of the overlapping seam, but still overlapping, GPU 18 weights the pixels on right sphere more than those on the left sphere (e.g., more weight to pixels on the right sphere than left sphere). The weighting for the blending changes progressively through the overlapping seam.

To perform the alpha blending, GPU 18 may perform another texturing pass to generate a mask texture. GPU 18 may use this mask texture with the color texture to generate the sphere of video content for the 360° video.

For example, CPU 16 may define a mask texture. The primitives that form the mask texture may be the same size and shape as the primitives that form color texture. In other words, the mask texture map may be the same as the color texture map used to define the texture coordinates for the pixels in the circular images. However, the values of the mask texture map may indicate the weighting used in the blending of the first and second portions. Unlike the color textures (e.g., the circular images), the mask texture is not an actual image with image content. Rather, the mask texture is a way to define the opacity of pixels within the portions (e.g., sub-capsules).

The mask texture map may be conceptually considered as being a gray-scale image with values ranging from 0 to 1, where 1 represents that 100% of the sub-capsule is used in the blending, and 0 represents that 0% of the sub-capsule is used in the blending. If the value in the mask texture map is between 0 and 1, then that value indicates the weighting applied to corresponding pixel in the sub-capsule, and the remainder weighting is applied to corresponding pixel in the other sub-capsule (e.g., blending between the two sub-capsules).

Camera module 12A and camera module 12B may be attached (e.g., rigidly attached) to a camera mount 25. Camera mount 25 may comprise a platform on a gimbal of a support structure (e.g., a tripod, monopod, selfie-stick, etc.). In some examples, camera mount 25 may comprise a platform of a robotic device. Servo interface 23 may comprise one or more devices configured to reposition camera mount 25. For example, servo interface 23 may comprise one or more motors (e.g., a servo) to reposition (e.g., rotate or move) camera mount 25. In some examples, servo interface 23 may represent motors of a robotic device.

In accordance with the techniques of the disclosure, camera module 12A may capture a first portion of a 360° field-of-view. Camera module 12B may capture a second portion of the 360° field-of-view. CPU 16 may select a target overlap region from a plurality of potential overlap regions of a scene captured by the first portion and the second portion based on a disparity in the scene. CPU 16 may cause camera module 12A, camera module 12B, or both camera module 12A and camera module 12B to reposition to a target camera setup based on the target overlap region. Camera module 12A and camera module 12B may capture the 360° field-of-view image with camera module 12A and camera module 12B arranged at the target camera setup. Accordingly, camera module 12A and camera module 12B may be rotated to position an overlap region away from a region of interest based on the disparity in the scene. In this way, CPU 16 may help to avoid warping artifacts resulting from parallax in features that are relatively close to computing device 10 that will likely result in a relatively high amount of warping artifacts.

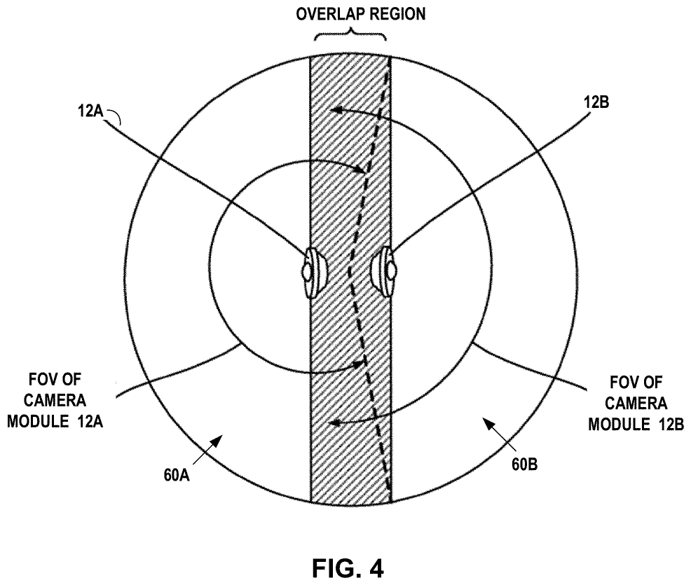

FIG. 4 is a conceptual diagram illustrating an example dual-fisheye arrangement, in accordance with one or more example techniques described in this disclosure. FIG. 4 illustrates first portion of a 360° field-of-view image 60A captured by camera module 12A and second portion of a 360° field-of-view image 60B captured by camera module 12B. As shown, there is an overlap region that includes first portion of 360° field-of-view image 60A captured by camera module 12A and second portion of a 360° field-of-view image 60B. Computing device 10 may generate a stitched 360° canvas based on first portion of 360° field-of-view image 60A captured by camera module 12A and second portion of a 360° field-of-view image 60B. The stitched 360° canvas may be referred to herein as a scene.

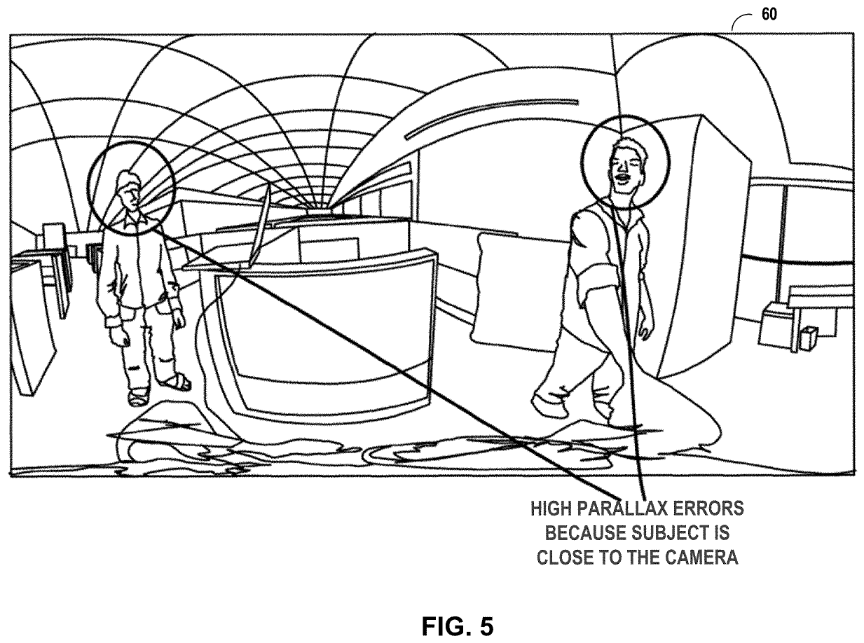

FIG. 5 is a conceptual diagram illustrating of artifacts due to parallax, in accordance with one or more example techniques described in this disclosure. As shown, 360° field-of-view image 60 may include parallax error when stitching images from camera module 12A and camera module 12B due to a difference between optical centers of camera module 12A and camera module 12B. Moreover, the parallax error may be further increased for features that are closer to camera modules 12A, 12B. For instance, 360° field-of-view image 60 may include high parallax errors in the faces of people due to people being relatively very close to camera modules 12A, 12B.

In accordance with the techniques of the disclosure, computing device 10 may cause servo interface 23 to reposition camera mount 25 (e.g., a gimbal or a platform of a robotic device) to reposition camera modules 12A, 12B to change the overlap region to reduce stitching (e.g., artifacts due to parallax) in scene 60. For example, computing device 10 may cause servo interface 23 to reposition camera mount 25 such that the overlap region does not include the faces of the people.

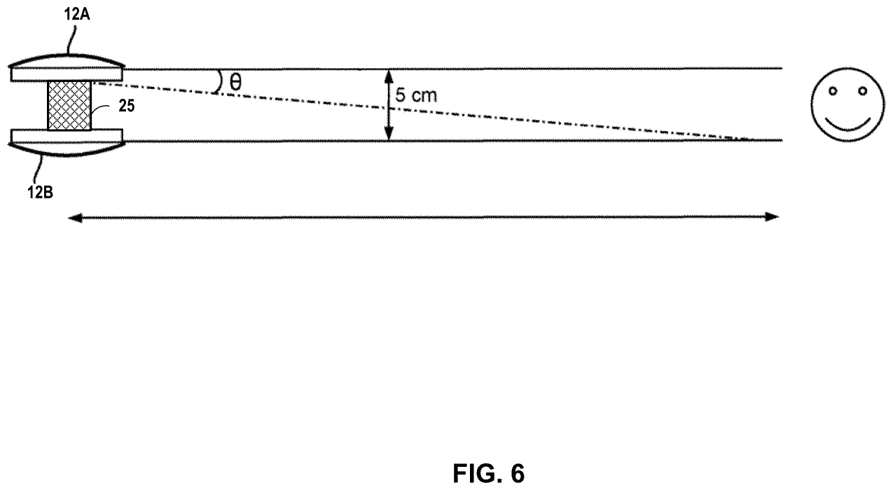

FIG. 6 is a conceptual diagram illustrating an example parallax computation, in accordance with one or more example techniques described in this disclosure. Parallax may occur because the same object will appear at different image locations in different cameras due to optical center difference. For example, camera module 12A and camera module 12B may capture the same object but the object will appear at different image locations in first portion of 360° field-of-view image 60A captured by camera module 12A and second portion of a 360° field-of-view image 60B. Techniques using static and/or dynamic stitching techniques may not actively direct camera mount 25 to minimize parallax errors. As such, static and/or dynamic stitching techniques may rely on only image processing to resolve parallax errors, which may result in warping artifacts in the overlap region due to parallax, particularly, for objects that are relatively close to a camera platform. For example, the parallax error (Delta_r) for a camera comprising a 5 cm separation between cameras (e.g., the distance between image sensors) may be calculated using equations 1-3.

tan θ=5/d EQUATION 1

R=f*θ; f=730 pixels EQUATION 2

Delta_r=730*tan−1(5/d) EQUATION 3

where θ is an angle between the cameras view of an object, d is a distance between the cameras and the object, f is a number of pixels (e.g., 730 pixels), tan−1 is an arctangent function, and Delta_r is a parallax error in pixels.

Table 1 illustrates a parallax error for different camera separation (e.g., the distance between image sensors) and object distances.

TABLE 1
Parallax error

| Camera | Object | Parallax |
|---|---|---|
| separation | distance | error |
| 5 cm | 36 m | 1 pixel |
| 5 cm | 1 m | 36 pixels |
| 1 cm | 7.2 m | 1 pixel |

CPU 16 and/or GPU 18 may determine the disparity in the scene based on a distance (e.g., in pixels) between a first position of an object in first portion of 360° field-of-view image 60A captured by camera module 12A and a second position of the object in second portion of 360° field-of-view image 60B captured by camera module 12B. In some examples, CPU 16 and/or GPU 18 may determine the disparity in the scene based on a depth map indicating, for each pixel in first portion of 360° field-of-view image 60A captured by camera module 12A and second portion of 360° field-of-view image 60B captured by camera module 12B, a relative distance from a capture device (e.g., computing device 10 or a robotic device comprising computing device 10) comprising the first camera module 12A and the second camera module 12B.

CPU 16 and/or GPU 18 may compute disparity using template matching. For example, CPU 16 and/or GPU 18 may match a patch of first portion of 360° field-of-view image 60A captured by camera module 12A against second portion of 360° field-of-view image 60B captured by camera module 12B. CPU 16 and/or GPU 18 may apply template matching that uses correlation based and feature based techniques.

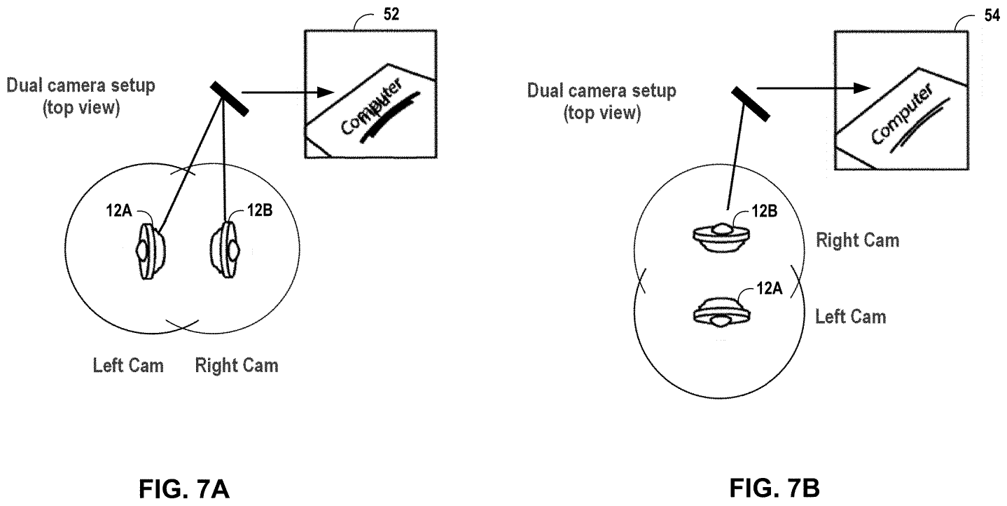

FIG. 7A is a conceptual diagram illustrating a first process in directing a camera system to reduce warping artifacts, in accordance with one or more example techniques described in this disclosure. In the example of FIG. 7A, computing device 10 may cause camera module 12A and camera module 12B to capture scene 52 with camera module 12A and camera module 12B arranged at a first target camera setup. As used herein, a camera setup may refer to a relative position and/or an orientation of first camera module 12A with second camera module 12B. As shown, scene 52 may include parallax errors after image processing. For instance, the word “Computer” may be warped.

FIG. 7B is a conceptual diagram illustrating a second process in directing a camera system to reduce warping artifacts, in accordance with one or more example techniques described in this disclosure. Computing device 10 may actively rotate the camera setup to a camera setup that results in the potential overlap region with the lowest cost. For example, computing device 10 may rotate from the first camera setup of FIG. 7A (e.g., a horizontal state) to a second camera setup (e.g., a vertical state) to reduce or eliminate parallax errors. For instance, the word “Computer” may be clearer in scene 54 than scene 52.

In the example of FIG. 7B, computing device 10 may cause servo interface 23 to reposition (e.g., move or rotate) camera mount 25 such that camera module 12A and camera module 12B capture scene 52 while arranged at a second target camera setup (e.g., vertical) that is different from the first target camera setup of FIG. 7A (e.g., horizontal). As shown, scene 54 may not include parallax errors after image processing.

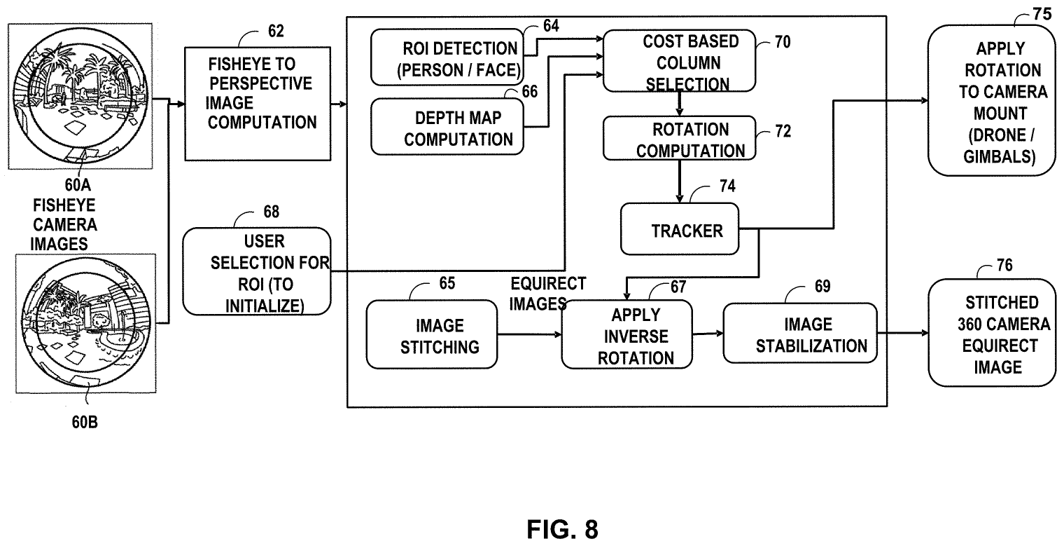

FIG. 8 is a conceptual diagram illustrating a process for generating a 360° image to reduce warping artifacts, in accordance with one or more example techniques described in this disclosure. FIG. 8 refers to computing device 10 of FIG. 3 for example purposes only.

One or more of camera processor 14, CPU 16, or GPU 18 may generate first portion of 360° field-of-view image 60A captured by camera module 12A and generate second portion of 360° field-of-view image 60B captured by camera module 12B (62). One or more of camera processor 14, CPU 16, or GPU 18 may generate 360° field-of-view image 60 using first portion of 360° field-of-view image 60A and second portion of 360° field-of-view image 60B.

In this example, one or more of camera processor 14, CPU 16, or GPU 18 may detect a region of interest (64). For example, one or more of camera processor 14, CPU 16, or GPU 18 may apply face detection to the scene to detect a person and/or a face of a person. One or more of camera processor 14, CPU 16, or GPU 18 may generate disparity information for scene (66). For example, one or more of camera processor 14, CPU 16, or GPU 18 may generate a depth map for 360° field-of-view image 60. As used herein, a depth map may indicate, for each pixel in a scene, a relative distance from computing device 10. User interface 22 may receive a user interaction that indicates a user selection of a region of interest (68).

One or more of camera processor 14, CPU 16, or GPU 18 may determine a cost based on one or more of the disparity information, the detected region of interest, or the user selection of a region of interest (70). For example, one or more of camera processor 14, CPU 16, or GPU 18 may determine a cost for each potential overlap region. One or more of camera processor 14, CPU 16, or GPU 18 may calculate the cost of each potential overlap region based on one or more of: whether the potential overlap region comprises a detected region of interest (e.g., a face), a disparity in a scene (e.g., a distance of objects in the potential overlap region and the camera setup), a user-selected region of interest, an activity, or sharp features.

One or more of camera processor 14, CPU 16, or GPU 18 may perform a rotation computation (72). For example, one or more of camera processor 14, CPU 16, or GPU 18 determine a target camera setup of camera module 12A and/or camera module 12B corresponding to a potential overlap region with a lowest cost compared to costs of other potential overlap regions. One or more of camera processor 14, CPU 16, or GPU 18 may apply a tracker to determine a reposition action to reposition the camera module 12A and/or camera module 12B to the target camera setup (74). For example, one or more of camera processor 14, CPU 16, or GPU 18 may apply a tracker process comprising a detection based tracker (to track faces) or an optical flow based process.

One or more of camera processor 14, CPU 16, or GPU 18 may apply rotation to camera mount (75). For example, one or more of camera processor 14, CPU 16, or GPU 18, with servo interface 23, may cause camera mount 25 to reposition to the target camera setup. In some examples, one or more of camera processor 14, CPU 16, or GPU 18 may cause a robotic device or gimbal to rotate to the target camera setup.

One or more of camera processor 14, CPU 16, or GPU 18 may generate, with camera module 12A and/or camera module 12B repositioned to the target camera setup, first portion of 360° field-of-view image 60A captured by camera module 12A and generate second portion of 360° field-of-view image 60B captured by camera module 12B. One or more of camera processor 14, CPU 16, or GPU 18 may apply image stitching (65).

One or more of camera processor 14, CPU 16, or GPU 18 may apply inverse rotation (67). For example, if service interface 23 applies a camera yaw rotation of 90 degrees to move the face of a person out of the stitching/overlap region, one or more of camera processor 14, CPU 16, or GPU 18 may apply an inverse rotation of 90 degrees so that the stitched output corresponds to a view before repositioning camera module 12A and/or camera module 12B.

One or more of camera processor 14, CPU 16, or GPU 18 may apply image stabilization (69) to generate the to generate the stitched 360° degree image using first portion of 360° field-of-view image 60A and second portion of 360° field-of-view image 60B with camera module 12A and/or camera module 12B repositioned to the target camera setup (76). For example, one or more of camera processor 14, CPU 16, or GPU 18 may apply optical and/or electronic based image stabilization.

In this way, computing device 10 may help to avoid warping artifacts resulting from parallax in features that are relatively close to computing device 10 that will likely result in a relatively high amount of warping artifacts.

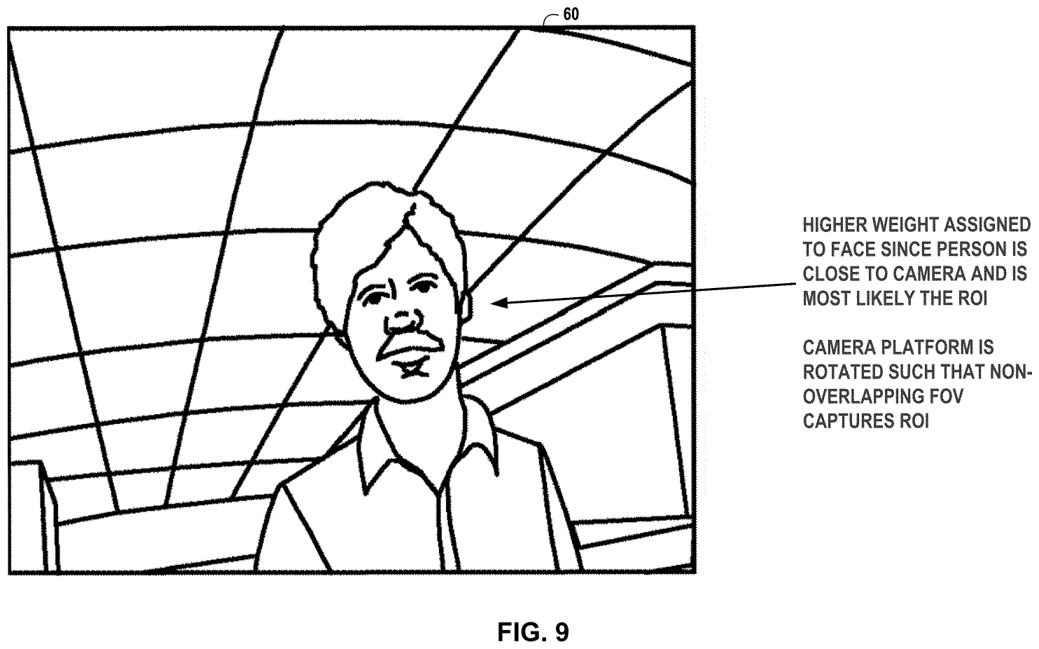

FIG. 9 is a pictorial diagram illustrating image content comprising a region of interest in a foreground, in accordance with one or more example techniques described in this disclosure. In the example of FIG. 9, 360° field-of-view image 60 may be captured with camera module 12A and camera module 12B arranged at the target camera setup.

In this example, 360° field-of-view image 60 the target camera setup may be determined using one or more processes described in FIG. 8. For example, CPU 16 may assign the face of the person a higher weight value because the person is close to camera module 12A and camera module 12B compared to other features in 360° field-of-view image 60 (e.g., a high disparity). In some examples, CPU 16 may assign the face of the person a higher weight value because the face of the person is a likely region of interest (e.g., using a user selected ROI or applying face detection).

In this example, CPU 16 may cause, with servo interface 23, camera mount 25 to rotate such that non-overlapping field-of-video captures the face of the person. For example, camera module 12A and camera module 12B may be mounted on a selfie stick using motorized gimbal such that the motorized gimbal moves the overlapping region away from the face of the person.

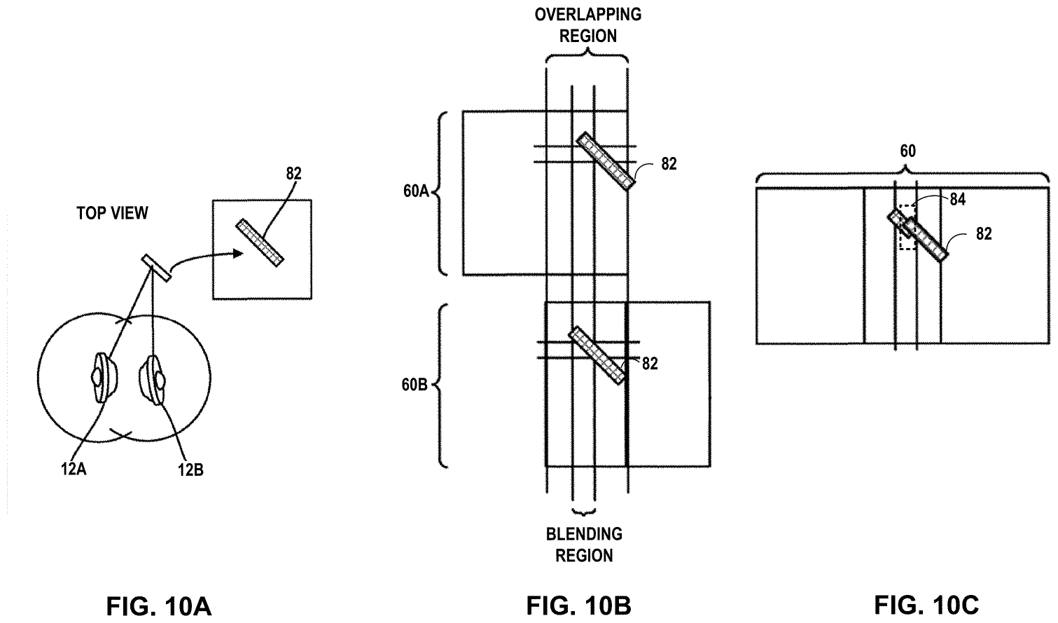

FIG. 10A is a conceptual diagram illustrating a first process for texture mapping techniques, in accordance with one or more example techniques described in this disclosure. In the example of FIG. 10A. Camera module 12A and camera module 12B capture feature 82 while arranged in a first camera setup (e.g., horizontal).

FIG. 10B is a conceptual diagram illustrating a second process for texture mapping techniques, in accordance with one or more example techniques described in this disclosure. In this example, GPU 18 may apply texture mapping techniques in an overlap region to stitch first portion of a 360° field-of-view image 60A captured using first camera module 12A and second portion of a 360° field-of-view image 60B captured using second camera module 12B to generate 360° field-of-view image 60.

FIG. 10C is a conceptual diagram illustrating a third process for texture mapping techniques, in accordance with one or more example techniques described in this disclosure. To account for differences between camera module 12A and second camera module 12B, GPU 18 may average sample values in the overlap region between first portion of the 360° field-of-view image 60A and second portion of the 360° field-of-view image 60B. For example, CPU 16 and/or GPU 18 may assign the first portion a higher weight value than the second portion for a left slice of the overlap region when camera module 12A is left of camera module 12B. In this example, CPU 16 and/or GPU 18 may assign the first portion and the second portion equal weight values for a middle slice of the overlap region. Further, CPU 16 and/or GPU 18 may assign the first portion a lower weight value than the second portion for a right slice of the overlap region. In this way, the overlap region may be used to blend first portion of the 360° field-of-view image 60A and second portion of the 360° field-of-view image 60B to generate a smoother complete 360° image than systems that do not average sample values in the overlap region.

In the example of FIG. 10C, GPU 18 may apply texture mapping techniques such that a warping artifact 84 appears in feature 82. The warping artifacts may result from parallax (e.g., a spatial difference of camera module 12A and camera module 12B), which may lower a user satisfaction. Moreover, features that are relatively close to the camera system (e.g., a face) may result in a relatively high amount of warping artifacts compared to features that are relatively far from the camera system (e.g., a background). As such, camera systems relying on texture mapping techniques may experience warping artifacts in regions of interest, particularly, in regions of interest positioned in a foreground.

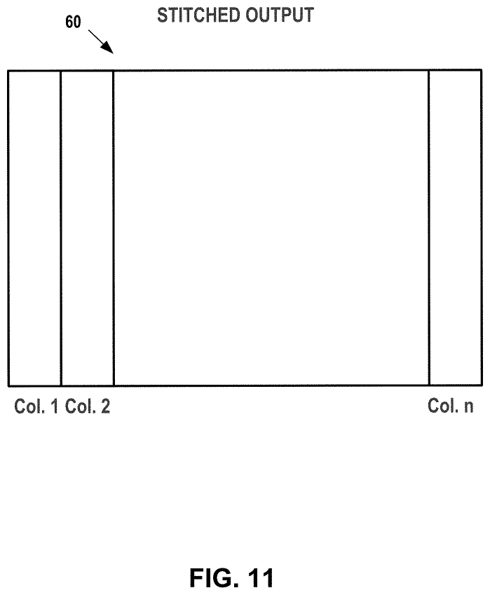

FIG. 11 is a conceptual diagram illustrating candidate columns for a stitched output, in accordance with one or more example techniques described in this disclosure. In the example of FIG. 11, CPU 16 may divide 360° field-of-view image 60 into ‘n’ number of columns (e.g., potential overlap regions). Each column may represent a different angle of camera module 12A and camera module 12B relative to a feature in 360° field-of-view image 60. For instance, each column may represent an angle position of servo interface 23.

In accordance with the techniques of the disclosure, CPU 16 may compute the cost for each column based on one or more of detecting a face, detecting a human being, detecting a region of interested, a disparity of an object in the scene, a user selection of a region of interest, an activity in the scene, or detecting sharp features in the scene (e.g., lines or corners). The CPU 16 may detect a region of interest based on an output from a deep learning network.

For example, CPU 16 may determine that a region of interest is captured in a target overlap region (e.g., one of columns 1-n) in response to detecting a feature in the target overlap region. For example, CPU 16 may apply face detection to the target overlap region to detect the feature in the target overlap region. In some examples, CPU 16 may determine a user selection of region of interest in the target overlap region. CPU 16 may determine an activity is captured in the target overlap region. For instance, CPU 16 may detect a motion in the target overlap region to determine the activity. For example, CPU 16 may detect activity by tracking objects in the overlap region and/or about to enter the overlap region.

In some examples, CPU 16 may determine that a sharp feature is captured in the target overlap region. As used herein, a sharp feature may comprise a line or a corner. In some examples, a sharp feature may include a geometric shape, such as, for example, a line corresponding to some object in the scene. Line detectors can be used for this. For instance, CPU 16 may applying sharp feature recognition to the target overlap region to determine the sharp feature is captured in the target overlap region.

CPU 16 may determine, for each one of the plurality of potential overlap regions, a set of disparity values. CPU 16 may determine, for each one of the plurality of potential overlap regions, a cost based on the set of disparity values. In some examples, CPU 16 may divide each one of the plurality of potential overlap regions into a plurality of rows. In this example, CPU 16 may determine, for each row of each respective one of the plurality of potential overlap regions, a respective disparity of the set of disparity values. For example, CPU 16 may apply equation 4a and/or equation 4b to the columns of 360° field-of-view image 60.

CPU 16 may calculate a cost of assigning (d₁^{t}, d₂^{t}, . . . dᵣ^{t}) as disparity values to rows (1, 2, . . . , R) for a column c as shown in EQUATION 4a.

$$cost ( {d}_{1}^{t} , {d}_{2}^{t} , … , {d}_{R}^{t} , c ) = {\sum }_{r} {d}_{r}^{t} * ( {λ}_{ROI} * {cost}_{ROI} + {λ}_{user} * {cost}_{user} + {λ}_{features} * {cost}_{features} ) \qquad EQUATION 4 a$$

cost_{ROI} is the cost of warping column c computed by a region of interest detector.
costᵤₛₑᵣ is the cost of warping column c although a user marked as region of interest.
cost_{features} is the cost of warping column c based on feature detection (to avoid warping sharp features such as lines).
λ_{ROI} is a weight value for the region of interest detector, λᵤₛₑᵣ is a weight value for the user marked region of interest, and λ_{features} is a weight value for the feature detection.

CPU 16 may calculate a cost of assigning (d₁^{t}, d₂^{t}, . . . dᵣ^{t}) as disparity values to rows (1, 2, . . . , R) for a column c as shown in EQUATION 4b.

$$cost ( {d}_{1}^{t} , {d}_{2}^{t} , … , {d}_{R}^{t} , c ) = {\sum }_{r} ( {λ}_{ROI} * f 1 ( {cost}_{ROI} , {d}_{r}^{t} ) + {λ}_{user} * f 2 ( {cost}_{user} , {d}_{r}^{t} ) + {λ}_{features} * f 3 ( {cost}_{features} , {d}_{r}^{t} ) ) \qquad EQUATION 4 b$$

λ_{ROI} is a weight value for the region of interest detector, λᵤₛₑᵣ is a weight value for the user marked region of interest, and λ_{features} is a weight value for the feature detection.
f1 is a function based on cost_{ROI} and dᵣ^{t}.
cost_{ROI} is the cost of warping column c computed by a region of interest detector.
f2 is a function based on costᵤₛₑᵣ and dᵣ^{t}.
costᵤₛₑᵣ is the cost of warping column c although a user marked as region of interest.
f3 is a function based on cost_{features} and d^{t}.
cost_{features} is the cost of warping column c based on feature detection (to avoid warping sharp features such as lines).

In the example of EQUATIONS 4a, 4b, the cost for each one of columns 1-n may be based on a combination of a detected region of interest, a user selected region of interest, and a feature detection. In some examples, one or more of the detected region of interest, the user selected region of interest, and the feature detection may be omitted or skipped from determining cost. Moreover, one or more other factors may be used to determine cost. For instance, an activity or sharp feature may be used to determine cost.

CPU 16 may compute a cost for each candidate column and consider the column with minimum cost for positioning camera. For example, CPU 16 may determine a cost for each potential overlap region (e.g., illustrated as columns 1-n). CPU 16 may select the potential overlap region of the plurality of potential overlap regions with a lowest cost as a target overlap region. In this example, CPU 16 may cause computing device 10 to rotate to cause the overlap region to correspond to a lowest cost overlap region (e.g., a target overlap region).

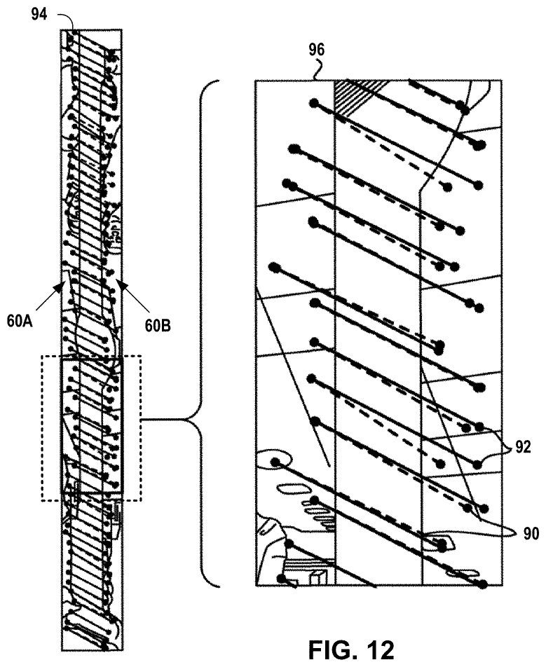

FIG. 12 is a conceptual diagram illustrating a disparity computation using dynamic programming, in accordance with one or more example techniques described in this disclosure. In this example, GPU 18 may apply normalized cross correlation (NCC) based disparity and depth sensing output disparity. GPU 18 may correct wrong matches in the NCC based disparity using dynamic programming (DP) output disparity. Examples of NCC and DP may be described in, for example, Banerjee et al., U.S. Pat. No. 10,244,164.

FIG. 12 illustrates NCC search based disparity 90 that include matching points and/or feature points between first portion of a 360° field-of-view image 60A and second portion of a 360° field-of-view image 60B. For example, GPU 18 may apply NCC based disparity to generate NCC search based disparity 90. In this example, GPU 18 may apply DP to generate DP output disparity 92, which may have an improved accuracy compared to systems that omit DP. In this way, computing device 10 may apply DP to help to reduce errors that occur when applying NCC, which may improve an accuracy of disparity values calculated by computer device 10. Improving the disparity values may help to improve the accuracy of calculating cost (e.g., calculating equation 4a and/or equation 4b), which, when using one or more techniques described herein, may improve a position of an overlap region to reduce warping artifacts, particularly, warping artifacts.

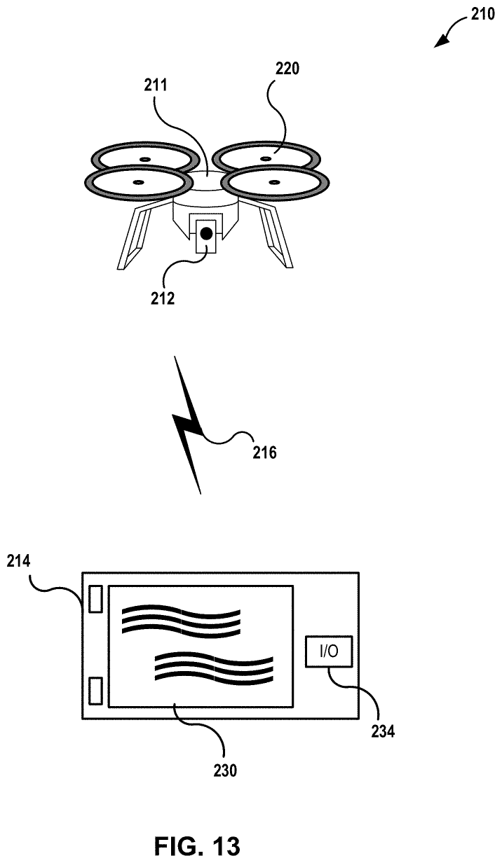

FIG. 13 is a conceptual diagram illustrating a robotic device 211, in accordance with one or more example techniques described in this disclosure. In the example approach of FIG. 12, system 210 includes robotic device 211 communicatively connected to a remote control 214 over a communication link 216. Communications link 16 may comprise a wireless communications link.

Robotic device 211 may include one or more rotors 220, and camera modules 212. Camera modules 212 may be cameras (e.g., with fisheye lenses) mounted on robotic device 211. Images and/or video captured by camera modules 212 may be transmitted via link 216 to remote control 214 such that the images and/or video may be seen and heard at remote control 214. Remote control 14 may include a display 230 and an input/output (I/O) interface 234. Display 230 may comprise a touchscreen display.

Communication link 216 may comprise any type of medium or device capable of moving the received signal data from robotic device 211 to remote control 214. Communication link 16 may comprise a communication medium that enables robotic device 211 to transmit received audio signal data directly to remote control 214 in real-time. The received signal data may be modulated according to a communication standard, such as a wireless communication protocol, and transmitted to remote control 214. The communication medium may comprise any wireless or wired communication medium, such as a radio frequency (RF) spectrum or one or more physical transmission lines. In one approach, the communication medium may form part of a packet-based network, such as a local area network, a wide-area network, or a global network such as the Internet. The communication medium may include routers, switches, base stations, or any other equipment that may be useful to facilitate communication between robotic device 211 and remote control 214.

In accordance with the techniques of the disclosure, camera modules 212 may capture a first portion of a 360° field-of-view and a second portion of the 360° field-of-view. Remote control 214 and/or robotic device 211 may select a target overlap region from a plurality of potential overlap regions of a scene captured by the first portion and the second portion based on a disparity in the scene. Remote control 214 and/or robotic device 211 may cause robotic device 211 to rotate camera modules 212 to reposition to a target camera setup based on the target overlap region. For example, remote control 214 and/or robotic device 211 may cause robotic device 211 to rotate around a yaw axis of robotic device 211 to a position corresponding to the target camera setup.

Camera modules 212 may capture the 360° field-of-view image with camera modules 212 arranged at the target camera setup. Accordingly, camera modules 212 may be rotated to position an overlap region away from a region of interest based on the disparity in the scene. In this way, remote control 214 and/or robotic device 211 may help to avoid warping artifacts resulting from parallax in features that are relatively close to robotic device 211 that will likely result in a relatively high amount of warping artifacts.

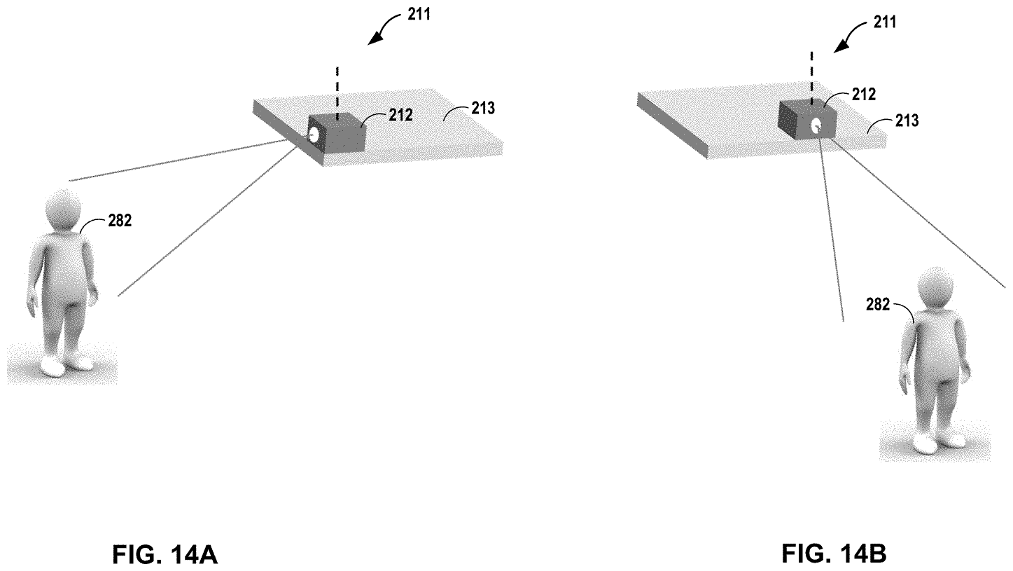

FIG. 14A is a conceptual diagram illustrating a first process of a rotation of camera modules 212 mounted on a robotic device 211, in accordance with one or more example techniques described in this disclosure. In the example of FIG. 14A, camera modules 212 are arranged at an initial camera setup of camera mount 213 (e.g., a platform).

FIG. 14B is a conceptual diagram illustrating a second process of a rotation of camera modules 212 mounted on robotic device 211, in accordance with one or more example techniques described in this disclosure. In the example of FIG. 14B, CPU 16 may cause robotic device 211 (e.g., a motor of robotic device or a servo for camera mount 213) to reposition camera mount 213 around a camera center of camera modules 212 to help ensure that a camera view of camera modules 212 does not change along a pitch of robotic device 211. For example, CPU 16 may cause, with robotic device 211, a rotation of camera mount 213 along a yaw axis such that camera modules 212 are arranged at a target camera setup. For instance, robotic device 211 may not be configured to hover at a tilted angle and CPU 16 may reposition robotic device 211 by a rotation of camera mount 213 around a single axis (e.g., a yaw axis) to achieve the target camera setup.

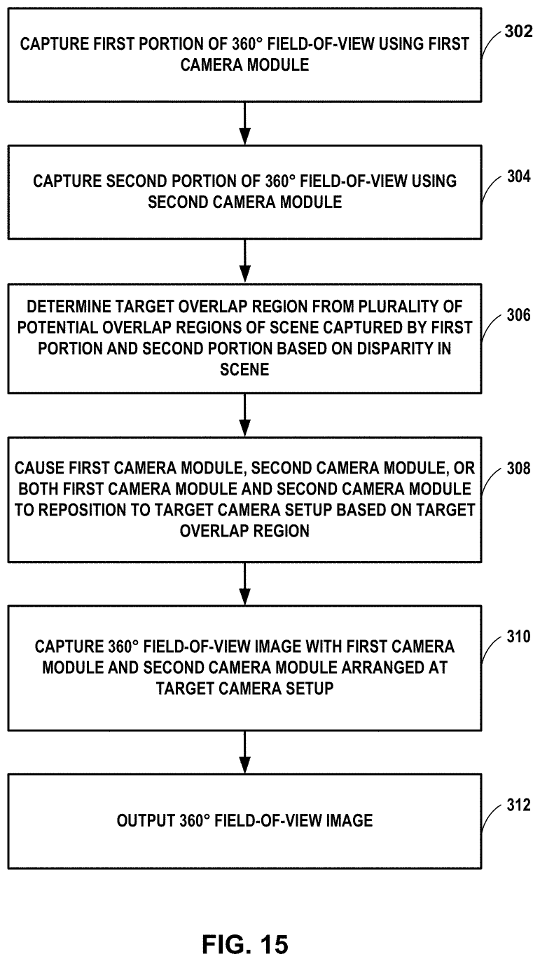

FIG. 15 is a flowchart illustrating an example method of operation according to one or more example techniques described in this disclosure. FIG. 15 is described using computing device 10 of FIG. 3 for example purposes only.

Computing device 10 may capture a first portion of a 360° field-of-view using a first camera module (302). For example, camera module 12A, with camera processor 14, may capture a first portion of a 360° field-of-view. Computing device 10 may capture a second portion of a 360° field-of-view using a second camera module (304). For example, camera module 12B, with camera processor 14, may capture a second portion of a 360° field-of-view.

CPU 16 may determine a target overlap region from a plurality of potential overlap regions of a scene captured by the first portion and the second portion based on a disparity in the scene (306). CPU 16 may cause, the first camera module, the second camera module, or both the first camera module and the second camera module to reposition to a target camera setup based on the target overlap region (308). For example, CPU 16 may cause, with servo interface 23, camera mount 25 (e.g., a gimbal) to rotate to a position corresponding to the target camera setup. In some examples, CPU 16 may cause robotic device 211, with servo interface 23, to rotate camera mount 213 (e.g., a platform) to a position corresponding to the target camera setup.

Camera processor 14 may capture a 360° field-of-view image with the first camera and the second camera arranged at the target camera setup. For example, camera module 12A, with camera processor 14, may capture a first portion of a 360° field-of-view with camera module 12A arranged at the target camera setup. In this example, camera module 12B, with camera processor 14, may capture a second portion of a 360° field-of-view with camera module 12B arranged at the target camera setup. For instance, CPU 16 may, with servo interface 23, cause camera mount 25 (e.g., a gimbal) to rotate to the target camera setup. In some instances, robotic device 211 may rotate camera mount 213 (e.g., a platform) to the target camera setup.

Computing device 10 may output the 360° field-of-view image (312). For example, computing device 10 may store the 360° field-of-view image in system memory 30. In some examples, computing device 10 may output the 360° field-of-view image at display 28. In some examples, remote control 214 may output the 360° field-of-view image at display 230.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The following clauses are a non-limiting list of examples in accordance with one or more techniques of this disclosure.

Clause A1: A method of capturing a 360° field-of-view image includes capturing, with one or more processors, a first portion of a 360° field-of-view using a first camera module; capturing, with the one or more processors, a second portion of the 360° field-of-view using a second camera module; determining, with the one or more processors, a target overlap region from a plurality of potential overlap regions of a scene captured by the first portion and the second portion based on a disparity in the scene; causing, with the one or more processors, the first camera, the second camera, or both the first camera and the second camera to reposition to a target camera setup based on the target overlap region; and capturing, with the one or more processors, the 360° field-of-view image with the first camera and the second camera arranged at the target camera setup.

Clause A2: The method of clause A1, wherein determining the target overlap region comprises: determining, for each one of the plurality of potential overlap regions, a set of disparity values; and determining, for each one of the plurality of potential overlap regions, a cost based on the set of disparity values.

Clause A3: The method of clause A2, wherein determining the target overlap region comprises selecting the potential overlap region of the plurality of potential overlap regions with a lowest cost as the target overlap region.

Clause A4: The method of any of clauses A2 and A3, wherein determining the set of disparity values comprises: dividing each one of the plurality of potential overlap regions into a plurality of rows; and determining, for each row of each respective one of the plurality of potential overlap regions, a respective disparity of the set of disparity values.

Clause A5: The method of any of clauses A2 through A4, further comprising determining, with the one or more processors, the disparity in the scene based on a distance between a first position of an object in the first portion and a second position of the object in the second portion.

Clause A6: The method of any of clauses A1 through A5, further comprising determining, with the one or more processors, the disparity in the scene based on a depth map indicating, for each pixel in the first portion and the second portion, a relative distance from a capture device comprising the first camera module and the second camera module.

Clause A7: The method of any of clauses A1 through A6, wherein the first camera module and the second camera module are mounted on a robotic device; and wherein causing the first camera, the second camera, or both the first camera and the second camera to reposition comprises causing the robotic device to reposition to the target camera setup.

Clause A8: The method of clause A7, wherein causing the robotic device to reposition comprises causing the robotic device to rotate around a yaw axis to a position corresponding to the target camera setup.

Clause A9: The method of any of clauses A1 through A8, further includes determining, with the one or more processors, that a region of interest is captured in the target overlap region in response to detecting a feature in the target overlap region; and wherein determining the target overlap region is further based on the determination that the region of interest is captured in the target overlap region.

Clause A10: The method of clause A9, wherein the feature is a face of a person and wherein detecting the feature comprises applying face detection to the target overlap region.

Clause A11: The method of any of clauses A1 through A10, further includes determining, with the one or more processors, a user selection of region of interest in the target overlap region; and wherein selecting the target overlap region is further based on the user selection of the region of interest in the target overlap region.

Clause A12: The method of any of clauses A1 through A11, further includes determining, with the one or more processors, that an activity is captured in the target overlap region; and wherein selecting the target overlap region is further based on the determination that the activity is captured in the target overlap region.

Clause A13: The method of clause A12, wherein determining that the activity is captured comprises detecting a motion in the target overlap region.

Clause A14: The method of any of clauses A1 through A13, further includes determining, with the one or more processors, that a sharp feature is captured in the target overlap region; and wherein selecting the target overlap region is further based on the determination that the sharp feature is captured in the target overlap region.

Clause A15: The method of clause A14, wherein the sharp feature is a line or a corner and wherein determining that the sharp feature is captured comprises applying sharp feature recognition to the target overlap region.

Clause A16: The method of any of clauses A1 through A15, wherein the first camera module includes a first fisheye lens and wherein the second camera module includes a second fisheye lens.

Clause A17: A device for capturing a 360° field-of-view image, the device comprising: a first camera module configured to capture a first portion of a 360° field-of-view; a second camera module configured to capture a second portion of the 360° field-of-view; a memory configured to store the first portion of the 360° field-of-view and the second portion of the 360° field-of-view; and one or more processors implemented in circuitry and configured to: cause the first camera to capture the first portion of a 360° field-of-view; cause the second camera to capture the second portion of the 360° field-of-view; determine a target overlap region from a plurality of potential overlap regions of a scene captured by the first portion and the second portion based on a disparity in the scene; cause the first camera, the second camera, or both the first camera and the second camera to rotate to a target camera setup based on the target overlap region; and capture the 360° field-of-view image with the first camera and the second camera arranged at the target camera setup.

Clause A18: The device of clause A17, wherein, to determine the target overlap region, the one or more processors are configured to: determine, for each one of the plurality of potential overlap regions, a set of disparity values; and determine, for each one of the plurality of potential overlap regions, a cost based on the set of disparity values.

Clause A19: The device of clause A18, wherein, to determine the target overlap region, the one or more processors are configured to determine the potential overlap region of the plurality of potential overlap regions with a lowest cost as the target overlap region.

Clause A20: The device of any of clauses A18 and A19, wherein, to determine the set of disparity values, the one or more processors are configured to: divide each one of the plurality of potential overlap regions into a plurality of rows; and determine, for each row of each respective one of the plurality of potential overlap regions, a respective disparity of the set of disparity values.

Clause A21: The device of any of clauses A18 through A20, wherein the one or more processors are further configured to determine the disparity in the scene based on a distance between a first position of an object in the first portion and a second position of the object in the second portion.

Clause A22: The device of any of clauses A17 through A21, wherein the one or more processors are further configured to determine the disparity in the scene based on a depth map indicating, for each pixel in the first portion and the second portion, a relative distance from a capture device comprising the first camera module and the second camera module.

Clause A23: The device of any of clauses A17 through A22, wherein the first camera module and the second camera module are mounted on a robotic device; and wherein, to cause the first camera, the second camera, or both the first camera and the second camera to reposition, the one or more processors are configured to cause the robotic device to reposition to the target camera setup.

Clause A24: The device of any of clauses A17 through A23, wherein, to cause the robotic device to reposition, the one or more processors are configured to cause the robotic device to rotate around a yaw axis to a position corresponding to the target camera setup.

Clause A25: The device of any of clauses A17 through A24, wherein the one or more processors are further configured to: determine that a region of interest is captured in the target overlap region in response to detecting a feature in the target overlap region; and wherein the one or more processors are configured to determine the target overlap region further based on the determination that the region of interest is captured in the target overlap region.

Clause A26: The device of clause A25, wherein the feature is a face of a person and wherein, to detect the feature, the one or more processors are configured to apply face detection to the target overlap region.

Clause A27: The device of any of clauses A17 through A26, wherein the one or more processors are further configured to: determine a user selection of region of interest in the target overlap region; and wherein the one or more processors are configured to determine the target overlap region further based on the user selection of the region of interest in the target overlap region.

Clause A28: The device of any of clauses A17 through A27, wherein the device comprises one or more a computer, a mobile device, a broadcast receiver device, or a set-top box.

Clause A29: A device for generating image content includes means for capturing a first portion of a 360° field-of-view using a first camera module; means for capturing a second portion of the 360° field-of-view using a second camera module; means for determining a target overlap region from a plurality of potential overlap regions of a scene captured by the first portion and the second portion based on a disparity in the scene; means for causing the first camera, the second camera, or both the first camera and the second camera to reposition to a target camera setup based on the target overlap region; and means for capturing the 360° field-of-view image with the first camera and the second camera arranged at the target camera setup.

Clause A30: A computer-readable storage medium having stored thereon instructions that, when executed, configure a processor to: capture a first portion of a 360° field-of-view using a first camera module; capture a second portion of the 360° field-of-view using a second camera module; determine a target overlap region from a plurality of potential overlap regions of a scene captured by the first portion and the second portion based on a disparity in the scene; cause the first camera, the second camera, or both the first camera and the second camera to reposition to a target camera setup based on the target overlap region; and capture the 360° field-of-view image with the first camera and the second camera arranged at the target camera setup.

Clause B1: A method of capturing a 360° field-of-view image includes capturing, with one or more processors, a first portion of a 360° field-of-view using a first camera module; capturing, with the one or more processors, a second portion of the 360° field-of-view using a second camera module; determining, with the one or more processors, a target overlap region from a plurality of potential overlap regions of a scene captured by the first portion and the second portion based on a disparity in the scene; causing, with the one or more processors, the first camera, the second camera, or both the first camera and the second camera to reposition to a target camera setup based on the target overlap region; and capturing, with the one or more processors, the 360° field-of-view image with the first camera and the second camera arranged at the target camera setup.

Clause B2: The method of clause B1, wherein determining the target overlap region comprises: determining, for each one of the plurality of potential overlap regions, a set of disparity values; and determining, for each one of the plurality of potential overlap regions, a cost based on the set of disparity values.

Clause B3: The method of clause B2, wherein determining the target overlap region comprises selecting the potential overlap region of the plurality of potential overlap regions with a lowest cost as the target overlap region.

Clause B4: The method of clause B2, wherein determining the set of disparity values comprises: dividing each one of the plurality of potential overlap regions into a plurality of rows; and determining, for each row of each respective one of the plurality of potential overlap regions, a respective disparity of the set of disparity values.

Clause B5: The method of clause B2, further comprising determining, with the one or more processors, the disparity in the scene based on a distance between a first position of an object in the first portion and a second position of the object in the second portion.

Clause B6: The method of clause B1, further comprising determining, with the one or more processors, the disparity in the scene based on a depth map indicating, for each pixel in the first portion and the second portion, a relative distance from a capture device comprising the first camera module and the second camera module.

Clause B7: The method of clause B1, wherein the first camera module and the second camera module are mounted on a robotic device; and wherein causing the first camera, the second camera, or both the first camera and the second camera to reposition comprises causing the robotic device to reposition to the target camera setup.

Clause B8: The method of clause B7, wherein causing the robotic device to reposition comprises causing the robotic device to rotate around a yaw axis to a position corresponding to the target camera setup.

Clause B9: The method of clause B1, further includes determining, with the one or more processors, that a region of interest is captured in the target overlap region in response to detecting a feature in the target overlap region; and wherein determining the target overlap region is further based on the determination that the region of interest is captured in the target overlap region.

Clause B10: The method of clause B9, wherein the feature is a face of a person and wherein detecting the feature comprises applying face detection to the target overlap region.

Clause B11: The method of any of clauses B1, further includes determining, with the one or more processors, a user selection of region of interest in the target overlap region; and wherein selecting the target overlap region is further based on the user selection of the region of interest in the target overlap region.

Clause B12: The method of clause B1, further includes determining, with the one or more processors, that an activity is captured in the target overlap region; and wherein selecting the target overlap region is further based on the determination that the activity is captured in the target overlap region.

Clause B13: The method of clause B12, wherein determining that the activity is captured comprises detecting a motion in the target overlap region.

Clause B14: The method of clause B1, further includes determining, with the one or more processors, that a sharp feature is captured in the target overlap region; and wherein selecting the target overlap region is further based on the determination that the sharp feature is captured in the target overlap region.

Clause B15: The method of clause B14, wherein the sharp feature is a line or a corner and wherein determining that the sharp feature is captured comprises applying sharp feature recognition to the target overlap region.

Clause B16: The method of clause B1, wherein the first camera module includes a first fisheye lens and wherein the second camera module includes a second fisheye lens.

Clause B17: A device for capturing a 360° field-of-view image, the device comprising: a first camera module configured to capture a first portion of a 360° field-of-view; a second camera module configured to capture a second portion of the 360° field-of-view; a memory configured to store the first portion of the 360° field-of-view and the second portion of the 360° field-of-view; and one or more processors implemented in circuitry and configured to: cause the first camera to capture the first portion of a 360° field-of-view; cause the second camera to capture the second portion of the 360° field-of-view; determine a target overlap region from a plurality of potential overlap regions of a scene captured by the first portion and the second portion based on a disparity in the scene; cause the first camera, the second camera, or both the first camera and the second camera to rotate to a target camera setup based on the target overlap region; and capture the 360° field-of-view image with the first camera and the second camera arranged at the target camera setup.

Clause B18: The device of clause B17, wherein, to determine the target overlap region, the one or more processors are configured to: determine, for each one of the plurality of potential overlap regions, a set of disparity values; and determine, for each one of the plurality of potential overlap regions, a cost based on the set of disparity values.

Clause B19: The device of clause B18, wherein, to determine the target overlap region, the one or more processors are configured to determine the potential overlap region of the plurality of potential overlap regions with a lowest cost as the target overlap region.

Clause B20: The device of clause B18, wherein, to determine the set of disparity values, the one or more processors are configured to: divide each one of the plurality of potential overlap regions into a plurality of rows; and determine, for each row of each respective one of the plurality of potential overlap regions, a respective disparity of the set of disparity values.

Clause B21: The device of clause B18, wherein the one or more processors are further configured to determine the disparity in the scene based on a distance between a first position of an object in the first portion and a second position of the object in the second portion.

Clause B22: The device of clauses B17, wherein the one or more processors are further configured to determine the disparity in the scene based on a depth map indicating, for each pixel in the first portion and the second portion, a relative distance from a capture device comprising the first camera module and the second camera module.

Clause B23: The device of clause B17, wherein the first camera module and the second camera module are mounted on a robotic device; and wherein, to cause the first camera, the second camera, or both the first camera and the second camera to reposition, the one or more processors are configured to cause the robotic device to reposition to the target camera setup.

Clause B24: The device of clause B17, wherein, to cause the robotic device to reposition, the one or more processors are configured to cause the robotic device to rotate around a yaw axis to a position corresponding to the target camera setup.

Clause B25: The device of clause B17, wherein the one or more processors are further configured to: determine that a region of interest is captured in the target overlap region in response to detecting a feature in the target overlap region; and wherein the one or more processors are configured to determine the target overlap region further based on the determination that the region of interest is captured in the target overlap region.

Clause B26: The device of clause B25, wherein the feature is a face of a person and wherein, to detect the feature, the one or more processors are configured to apply face detection to the target overlap region.

Clause B27: The device of clause B17, wherein the one or more processors are further configured to: determine a user selection of region of interest in the target overlap region; and wherein the one or more processors are configured to determine the target overlap region further based on the user selection of the region of interest in the target overlap region.

Clause B28: The device of clause B17, wherein the device comprises one or more a computer, a mobile device, a broadcast receiver device, or a set-top box.

Clause B29: A device for generating image content includes means for capturing a first portion of a 360° field-of-view using a first camera module; means for capturing a second portion of the 360° field-of-view using a second camera module; means for determining a target overlap region from a plurality of potential overlap regions of a scene captured by the first portion and the second portion based on a disparity in the scene; means for causing the first camera, the second camera, or both the first camera and the second camera to reposition to a target camera setup based on the target overlap region; and means for capturing the 360° field-of-view image with the first camera and the second camera arranged at the target camera setup.

Clause B30: A computer-readable storage medium having stored thereon instructions that, when executed, configure a processor to: capture a first portion of a 360° field-of-view using a first camera module; capture a second portion of the 360° field-of-view using a second camera module; determine a target overlap region from a plurality of potential overlap regions of a scene captured by the first portion and the second portion based on a disparity in the scene; cause the first camera, the second camera, or both the first camera and the second camera to reposition to a target camera setup based on the target overlap region; and capture the 360° field-of-view image with the first camera and the second camera arranged at the target camera setup.

Various examples have been described. These and other examples are within the scope of the following claims.

1. A method of capturing a 360° field-of-view image, the method comprising:
capturing, with one or more processors, a first portion of a 360° field-of-view using a first camera module;
capturing, with the one or more processors, a second portion of the 360° field-of-view using a second camera module;
determining, with the one or more processors, a target overlap region from a plurality of potential overlap regions of a scene captured by the first portion and the second portion based on a disparity in the scene, wherein each potential overlap region of the plurality of potential overlap regions represents a different angle of the first camera module and the second camera module relative to a feature of the 360° field-of-view;
causing, with the one or more processors, the first camera module, the second camera module, or both the first camera module and the second camera module to reposition to a target camera setup based on the target overlap region; and
capturing, with the one or more processors, the 360° field-of-view image with the first camera and the second camera arranged at the target camera setup.

2. The method of claim 1, wherein determining the target overlap region comprises:
determining, for each one of the plurality of potential overlap regions, a set of disparity values; and
determining, for each one of the plurality of potential overlap regions, a cost based on the set of disparity values.

3. The method of claim 2, wherein determining the target overlap region comprises selecting the potential overlap region of the plurality of potential overlap regions with a lowest cost as the target overlap region.

4. The method of claim 2, wherein determining the set of disparity values comprises:
dividing each one of the plurality of potential overlap regions into a plurality of rows; and
determining, for each row of each respective one of the plurality of potential overlap regions, a respective disparity of the set of disparity values.

5. The method of claim 2, further comprising determining, with the one or more processors, the disparity in the scene based on a distance between a first position of an object in the first portion and a second position of the object in the second portion.

6. The method of claim 1, further comprising determining, with the one or more processors, the disparity in the scene based on a depth map indicating, for each pixel in the first portion and the second portion, a relative distance from a capture device comprising the first camera module and the second camera module.

7. The method of claim 1,
wherein the first camera module and the second camera module are mounted on a robotic device; and
wherein causing the first camera module, the second camera module, or both the first camera module and the second camera module to reposition comprises causing the robotic device to reposition to the target camera setup.

8. The method of claim 7, wherein causing the robotic device to reposition comprises causing the robotic device to rotate around a yaw axis to a position corresponding to the target camera setup.

9. The method of claim 1, further comprising:
determining, with the one or more processors, that a region of interest is captured in the target overlap region in response to detecting the feature in the target overlap region; and
wherein determining the target overlap region is further based on the determination that the region of interest is captured in the target overlap region.

10. The method of claim 9, wherein the feature is a face of a person and wherein detecting the feature comprises applying face detection to the target overlap region.

11. The method of claim 1, further comprising:
determining, with the one or more processors, a user selection of region of interest in the target overlap region; and
wherein selecting the target overlap region is further based on the user selection of the region of interest in the target overlap region.

12. The method of claim 1, further comprising:
determining, with the one or more processors, that an activity is captured in the target overlap region; and
wherein selecting the target overlap region is further based on the determination that the activity is captured in the target overlap region.

13. The method of claim 12, wherein determining that the activity is captured comprises detecting a motion in the target overlap region.

14. The method of claim 1, further comprising:
determining, with the one or more processors, that a sharp feature is captured in the target overlap region; and
wherein selecting the target overlap region is further based on the determination that the sharp feature is captured in the target overlap region.

15. The method of claim 14, wherein the sharp feature is a line or a corner and wherein determining that the sharp feature is captured comprises applying sharp feature recognition to the target overlap region.

16. The method of claim 1, wherein the first camera module includes a first fisheye lens and wherein the second camera module includes a second fisheye lens.

17. A device for capturing a 360° field-of-view image, the device comprising:
a first camera module configured to capture a first portion of a 360° field-of-view;
a second camera module configured to capture a second portion of the 360° field-of-view;
a memory configured to store the first portion of the 360° field-of-view and the second portion of the 360° field-of-view; and
one or more processors implemented in circuitry and configured to:
cause the first camera to capture the first portion of a 360° field-of-view;
cause the second camera to capture the second portion of the 360° field-of-view;
determine a target overlap region from a plurality of potential overlap regions of a scene captured by the first portion and the second portion based on a disparity in the scene, wherein each potential overlap region of the plurality of potential overlap regions represents a different angle of the first camera module and the second camera module relative to a feature of the 360° field-of-view;
cause the first camera module, the second camera module, or both the first camera module and the second camera module to rotate to a target camera setup based on the target overlap region; and
capture the 360° field-of-view image with the first camera and the second camera arranged at the target camera setup.

18. The device of claim 17, wherein, to determine the target overlap region, the one or more processors are configured to:
determine, for each one of the plurality of potential overlap regions, a set of disparity values; and
determine, for each one of the plurality of potential overlap regions, a cost based on the set of disparity values.

19. The device of claim 18, wherein, to determine the target overlap region, the one or more processors are configured to determine the potential overlap region of the plurality of potential overlap regions with a lowest cost as the target overlap region.

20. The device of claim 18, wherein, to determine the set of disparity values, the one or more processors are configured to:
divide each one of the plurality of potential overlap regions into a plurality of rows; and
determine, for each row of each respective one of the plurality of potential overlap regions, a respective disparity of the set of disparity values.

21. The device of claim 18, wherein the one or more processors are further configured to determine the disparity in the scene based on a distance between a first position of an object in the first portion and a second position of the object in the second portion.

22. The device of claim 17, wherein the one or more processors are further configured to determine the disparity in the scene based on a depth map indicating, for each pixel in the first portion and the second portion, a relative distance from a capture device comprising the first camera module and the second camera module.

23. The device of claim 17, wherein the first camera module and the second camera module are mounted on a robotic device; and
wherein, to cause the first camera module, the second camera module, or both the first camera module and the second camera module to reposition, the one or more processors are configured to cause the robotic device to reposition to the target camera setup.

24. The device of claim 23, wherein, to cause the robotic device to reposition, the one or more processors are configured to cause the robotic device to rotate around a yaw axis to a position corresponding to the target camera setup.

25. The device of claim 17, wherein the one or more processors are further configured to:
determine that a region of interest is captured in the target overlap region in response to detecting the feature in the target overlap region; and
wherein the one or more processors are configured to determine the target overlap region further based on the determination that the region of interest is captured in the target overlap region.

26. The device of claim 25, wherein the feature is a face of a person and wherein, to detect the feature, the one or more processors are configured to apply face detection to the target overlap region.

27. The device of claim 17, wherein the one or more processors are further configured to:
determine a user selection of region of interest in the target overlap region; and
wherein the one or more processors are configured to determine the target overlap region further based on the user selection of the region of interest in the target overlap region.

28. The device of claim 17, wherein the device comprises one or more of a computer, a mobile device, a broadcast receiver device, or a set-top box.

29. A device for generating image content, the device comprising:
means for capturing a first portion of a 360° field-of-view using a first camera module;
means for capturing a second portion of the 360° field-of-view using a second camera module;
means for determining a target overlap region from a plurality of potential overlap regions of a scene captured by the first portion and the second portion based on a disparity in the scene, wherein each potential overlap region of the plurality of potential overlap regions represents a different angle of the first camera module and the second camera module relative to a feature of the 360° field-of-view;
means for causing the first camera module, the second camera module, or both the first camera module and the second camera module to reposition to a target camera setup based on the target overlap region; and
means for capturing the 360° field-of-view image with the first camera and the second camera arranged at the target camera setup.

30. A non-transitory computer-readable storage medium having stored thereon instructions that, when executed, configure a processor to:
capture a first portion of a 360° field-of-view using a first camera module;
capture a second portion of the 360° field-of-view using a second camera module;
determine a target overlap region from a plurality of potential overlap regions of a scene captured by the first portion and the second portion based on a disparity in the scene, wherein each potential overlap region of the plurality of potential overlap regions represents a different angle of the first camera module and the second camera module relative to a feature of the 360° field-of-view;
cause the first camera module, the second camera module, or both the first camera module and the second camera module to reposition to a target camera setup based on the target overlap region; and
capture the 360° field-of-view image with the first camera and the second camera arranged at the target camera setup.
